(19) United States
(12) Patent Application Publication
(10) Pub. No.: US 2003/0156787 A1
(43) Pub. Date: Aug. 21, 2003

(54) Systems and methods for aligning optical fiber to light source or detector

(76) Inventors: Gregory A. King, Lakeville, MN (US); Iain Ross MacTaggart, Eden Prairie, MN (US)

Correspondence Address: SCHWEGMAN, LUNDBERG, WOESSNER & KLUTH, P.A., P.O. BOX 2938, MINNEAPOLIS, MN, 55402, US

(21) Appl. No.: 10/079,048

(22) Filed: Feb. 19, 2002

(51) Int. Cl. G02B 6/26; G02B 6/42

(52) U.S. Cl. 385/31; 385/52; 385/15

(57) ABSTRACT

This document describes systems and methods for aligning an optical fiber to a light source or detector. In one example, the alignment is based on a measured amplitude. In another example, the alignment is based on a measured jitter. In another example, the alignment is based on a combination of the measured amplitude and the measured jitter. In another example, the alignment is based on a combination of a measured quiescent response in combination with at least one of the measured amplitude and the measured jitter. The alignment may be performed manually or automatically. By securing the optical fiber in a properly aligned position, improved coupling to the light source or detector is obtained.

### TECHNICAL FIELD

This document relates generally to optical and electronic data communication systems and methods, and particularly, but not by way of limitation, to systems and methods for aligning optical fiber(s) to optical subassembly module(s).

### BACKGROUND

High-speed data communication often uses optical signals (light) communicated using optical fibers. Such optical fibers typically must interface with optoelectronic components, such as a transmitter that outputs an optical signal in response to an input electrical signal, or a receiver that detects a received optical signal and outputs a resulting electrical signal. The electronics of such optoelectronic components (e.g., a laser and accompanying circuitry of a transmitter, or a semiconductor diode light detector, or other light detector, and accompanying circuitry of a receiver, or both) may be carried by or housed in an optical subassembly (OSA) module.

Properly aligning an optical fiber and a light source or detector of the OSA module is important. Improper alignment may reduce the strength of the transmitted optical signal or the detected optical signal being transduced into an electrical signal. As a result, the integrity of the data being communicated may be degraded by the presence of noise, such as from the electronic circuit components or from external interference. Tan U.S. Pat. No. 5,029,965 discusses a method for aligning an optical fiber to an active device. In the Tan patent, the position of the optical fiber is apparently adjusted based on an evaluation of the power output generated by a PIN light detector. This power output of the light detector is, in turn, computed using a current generated by light impacting an active area of the light detector. However, the present inventors have recognized that adjusting the position of the optical fiber solely in response to a light detector power output is time-consuming, and may not always result in the most accurate alignment. For these and other reasons, the present inventors have recognized that there exists an unmet need for improved techniques of aligning an optical fiber to a light source and/or light detector.

### BRIEF DESCRIPTION OF THE DRAWINGS

In the drawings, which are offered by way of example, and not by way of limitation, and which are not necessarily drawn to scale, like numerals describe substantially similar components throughout the several views. Like numerals having different letter suffixes represent different instances of substantially similar components.

FIG. 1 is a schematic/block diagram illustrating generally, by way of example, but not by way of limitation, a system that communicates data over one or more optical fibers.

FIG. 2 is a schematic/block diagram illustrating generally, by way of example, but not by way of limitation, a system configured to accurately align an optical fiber to an optical input of an optical subassembly (“OSA”) module.

FIG. 3 is a graph illustrating generally, by way of example, but not by way of limitation, a current-to-voltage transfer characteristic of a programmable gain transimpedance amplifier.

FIG. 4 is a first printed output of a display from a sampling oscilloscope.

FIG. 5 is a second printed output of a display from the sampling oscilloscope after performing some manual alignment of an end of an optical fiber to an optical input of a light detector.

FIG. 6 is a third printed output of a display from the sampling oscilloscope after aligning an end of an optical fiber to an optical input of a light detector based on maximizing the measured peak-to-peak voltage amplitude and minimizing the zero-crossing jitter of the electrical signal at node/bus.

### DETAILED DESCRIPTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that the embodiments may be combined, or that other embodiments may be utilized and that structural, logical and electrical changes may be made without departing from the spirit and scope of the present invention.

The following detailed description is, therefore, not to be taken in a limiting sense, and the scope of the present invention is defined by the appended claims and their equivalents.

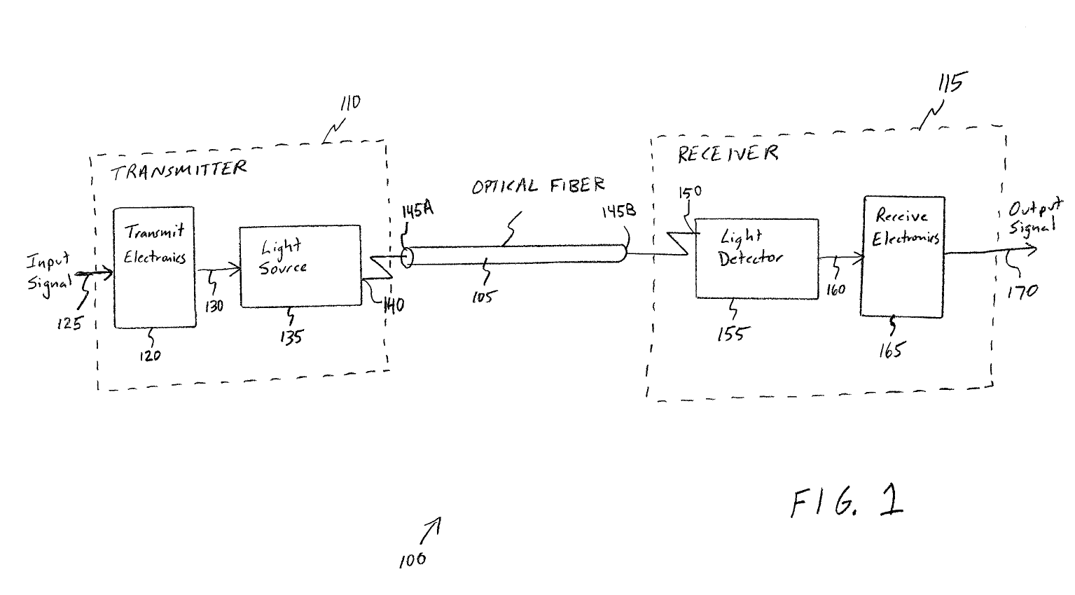

FIG. 1 is a schematic/block diagram illustrating generally, by way of example, but not by way of limitation, a system 100 that communicates data over one or more optical fibers 105. In this example, system 100 includes transmitter 110 and receiver 115. Transmitter 110 includes a transmit electronics circuit 120, having an input at node/bus 125 for receiving an electrical input signal carrying data. Using this data, transmit electronics circuit 120 provides an output, at node/bus 130, that outputs an electrical control signal to drive a laser or other suitable light source 135. Light source 135 includes an output 140 that transmits a resulting optical signal into a first end 145A of optical fiber 105. The optical signal is received, at a second end 145B of optical fiber 105, at an optical input 150 of a PIN semiconductor or other light detector 155 of receiver 115. The received optical signal is transduced by light detector 155 into a resulting electrical signal at node/bus 160. The resulting electrical signal at node/bus 160 is received at an input of receive electronics circuit 165, where it undergoes any buffering, amplification, filtering, or other signal processing. Receive electronics circuit 165 outputs a responsive processed electrical output signal at node/bus 170. In the example of FIG. 1, one or both of the respective first and second ends 145A-B of optical fiber 105 are positioned, using techniques discussed below, with respect to the optical output 140 of light source 135 and the optical input of light detector 155, respectively. As one alternative to the example of FIG. 1, transmitter 110 and receiver 115 may be combined into a transceiver, in which an optical output 140 of light source 135 and/or an optical input 150 of light detector 155 are positioned with respect to an end of the same or different optical fibers 105. In either example, the electrical and/or optical components may be carried by or housed in a printed circuit (“PC”) board-mounted or other optical subassembly (OSA) module, with respect to which optical fiber 105 is positioned using the techniques discussed below.

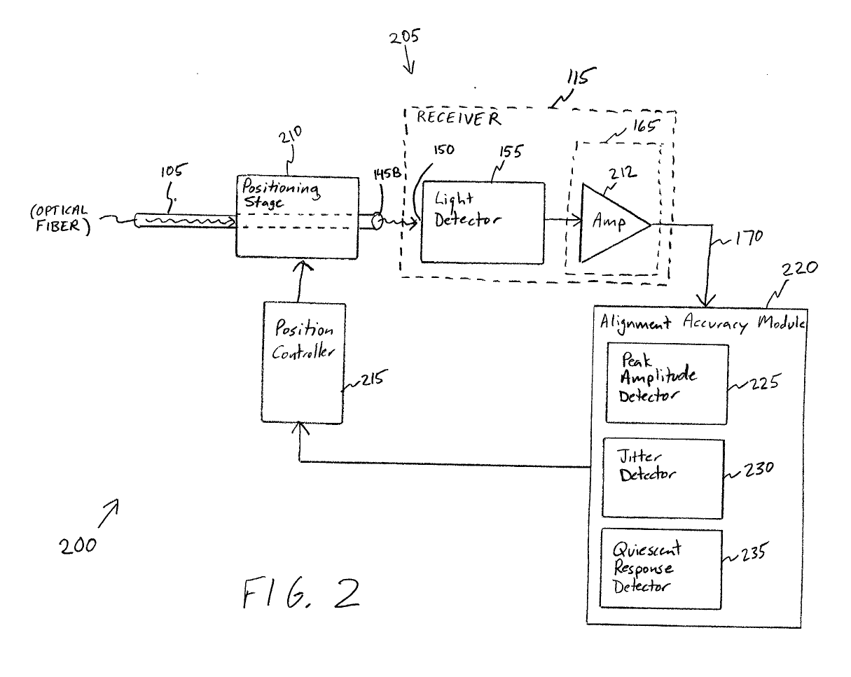

FIG. 2 is a schematic/block diagram illustrating generally, by way of example, but not by way of limitation, a system 200 configured to accurately align optical fiber 105 to an optical input 150 of OSA 205. In this example, a positioning stage 210 adjusts the position of end 145B of optical fiber 105 to obtain accurate alignment with optical input 150 of OSA 205. The location of positioning stage 210 is adjusted using control signals provided by an XYZ or other position controller 215. Optical fiber 105 is then secured in such a position, obtaining improved detection of the optical signal being communicated through optical fiber 105. In this example of system 200, OSA 205 includes a receiver 115, which, in turn, includes light detector 155 and receive electronics 165. In one example, light detector 155 includes a PIN semiconductor light detector (which typically includes a sandwich structure of a p-type semiconductor, an intrinsic semiconductor, and an n-type semiconductor) that generates a photocurrent in response to light received at optical input 150. In this example, receive electronics 165 includes a transimpedance amplifier 212 that converts the input photocurrent received from light detector 155 into a resulting voltage signal at node/bus 170. By communicating a time-varying (e.g., sine wave, square wave, triangle wave, etc.) optical signal through optical fiber 105, the resulting electrical signal at node/bus 170 will also be time-varying.

The time-varying electrical signal at node/bus 170 is received at an input of an alignment accuracy module 220, which measures one or more parameters of the electrical signal at node/bus 170, and uses the measured parameter as a basis for aligning optical fiber 105. In one example, the measured variable(s) are stored in a memory array of alignment accuracy module 220, the memory array elements corresponding to various positions of positioning stage 210 scanned by position controller 215. In one example, alignment accuracy module 220 includes a peak amplitude detector 225 circuit, for measuring an amplitude (e.g., zero-to-peak or peak-to-peak) of the electrical signal at node/bus 170. In this example, optical fiber 105 is aligned to a position that maximizes (or otherwise generally increases) the measured amplitude. In another example, alignment accuracy module 220 includes a jitter detector 230 circuit, for measuring a jitter of the electrical signal at node/bus 170. In one example, the measured jitter is determined from statistical variations in zero-crossings (over a time period that includes many such zero-crossings) of the electrical signal at node/bus 170. In this example, optical fiber 105 is aligned to a position that minimizes (or otherwise generally decreases) the measured jitter. In a further example, optical fiber 105 is aligned to a position that both maximizes or increases measured amplitude and minimizes or decreases jitter. These variables can be combined linearly (which may include multiplicative or other prescaling one or both of these parameters), multiplicatively, exponentially, or in any other fashion. In yet a further example, alignment accuracy module 220 includes a quiescent response detector 235, which measures a steady-state or slowly-varying component of the electrical signal at node/bus 170 (e.g., DC current, DC power, etc.). In this example, optical fiber 105 is aligned to a position that (1) maximizes or increases the quiescent response measured by quiescent response detector 235 and (2) either maximizes or increases the measured amplitude, or minimizes or decreases the measured jitter, or both. After being properly aligned, the optical fiber 115 is secured, such as by using epoxy that quickly cures upon exposure to ultraviolet light, or by using a physical clamp or detent, or by any other technique of securing an optical fiber 105. Although position controller 215 and positioning stage 210 perform automated positioning of optical fiber 105, in an alternative example, alignment accuracy module 220 includes a user-interface that provides an indicator of the measured variable, so that a human user can perform the alignment of optical fiber 105 using the measured variable to assist in determining proper alignment. In one example of human alignment, the amplitude, jitter, or quiescent measurement(s) are performed by a human operator viewing the electrical signal at node/bus 170 on an oscilloscope, and adjusting the position of optical fiber 105, accordingly.

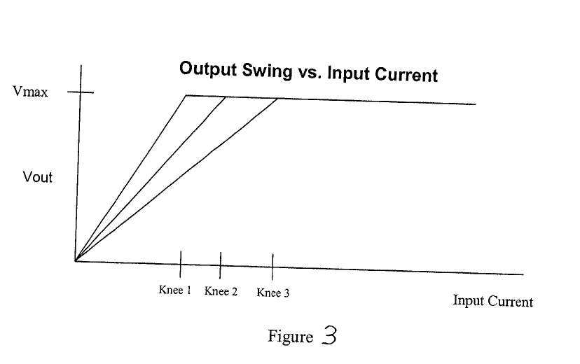

In one example, transimpedance amplifier 212 includes a current-to-voltage transfer characteristic having a region that is substantially linear. In one example, the gain of transimpedance amplifier 212 is programmable, as illustrated in the exemplary graph of FIG. 3. Properly selecting the gain of transimpedance amplifier 212 increases the dynamic range of the electrical signal provided at node/bus 170. This increases the accuracy of the measured amplitude, jitter, or quiescent response, which, in turn, increases the accuracy with which optical fiber 105 is aligned. In a further example, an automatic gain control (“AGC”) circuit automatically controls the gain setting of transimpedance amplifier 212 so as to automatically provide wide dynamic range of the electrical signal at node/bus 170, thereby obtaining the measurement and resulting alignment benefits described above.

Although FIG. 2 illustrates an example in which end 145B of optical fiber 105 is positioned with respect to an optical input 150 of light detector 155, it also applies to aligning an end 145A with respect to an optical output 140 of a light source 135, such as by securing end 145B in a fixed position and moving positioning stage 210 so that it positions a portion of optical fiber 105 near end 145A using alignment information from one or more of the measured variables described above. In one such example of aligning an end 145A with respect to an optical output 140 of light source 135, receiver 115 is included as part of an optical input interface of an oscilloscope used by a human operator to measure amplitude, jitter, or a quiescent response for performing the alignment.

Also, although FIG. 2 illustrates a single optical fiber 105 for conceptual clarity, the systems and methods described in this document also apply to alignment of multiple optical fibers 105. In such one example, a ribbon carries a linear array of 12 such optical fibers 105. In one example of aligning multiple optical fibers 105 to multiple light source outputs or light detector inputs, the process described above is iterated or otherwise repeated for each optical fiber 105 in the ribbon. The alignment need not proceed serially through adjacent optical fibers 105. In one example, the optical fibers 105 at the ends of the linear array are aligned first, then the ribbon is fine-tuned using measured data from the end optical fibers 105 and/or the intervening optical fibers 105. The measured data may also be weighted differently, for example, depending on which optical fiber 105 is associated with the measured data.

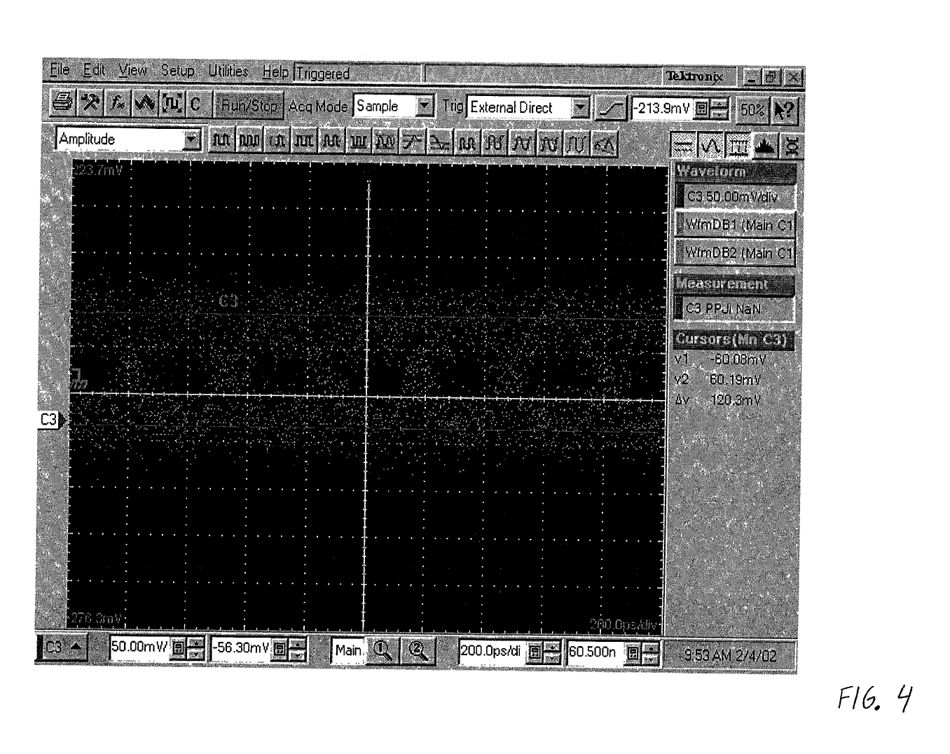

FIG. 4 is a first printed output of a display from a sampling oscilloscope. It illustrates several repeated occurrences of a sinusoidal electrical signal at node/bus 170; the display of each such occurrence is triggered for display on the oscilloscope by the same voltage trigger level. In the example of FIG. 4, the end 145B of optical fiber 105 has been placed in approximate position with respect to the optical input 150 of light detector 155, but without undertaking any particular alignment. The “cloud” of sample points illustrated in FIG. 4 shows a relatively small peak-to-peak voltage magnitude of about 120 mV, and substantial jitter in the zero-crossings of the sine wave.

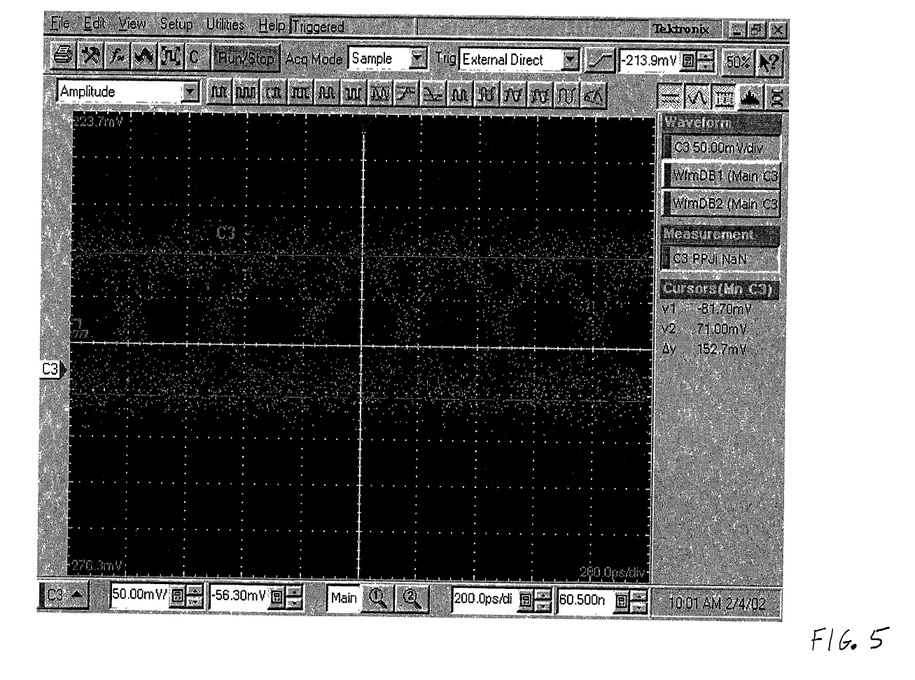

FIG. 5 is a second printed output of a display from the sampling oscilloscope after performing some manual alignment of the end 145B of optical fiber 105 to the optical input 150 of light detector 155. The peak-to-peak voltage magnitude has increased to about 150 mV, and the jitter has been reduced slightly.

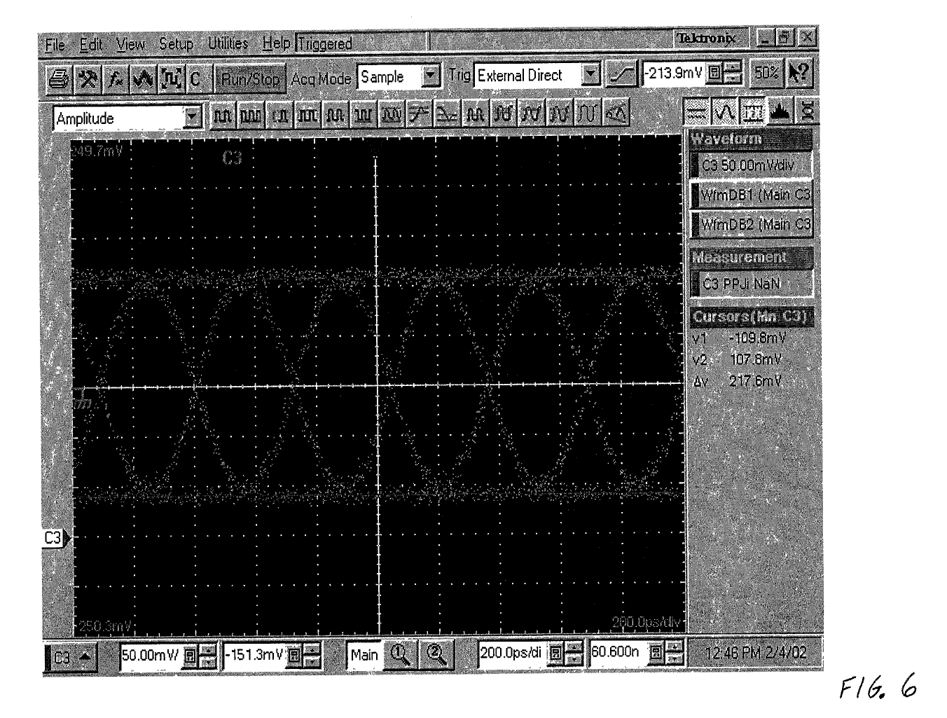

FIG. 6 is a third printed output of a display from the sampling oscilloscope after aligning end 145B of optical fiber 105 to the optical input 150 of light detector 155 based on maximizing the measured peak-to-peak voltage amplitude and minimizing the zero-crossing jitter of the electrical signal at node/bus 170. The peak-to-peak voltage has increased to about 220 mV, and the jitter has been substantially reduced.

It is to be understood that the above description is intended to be illustrative, and not restrictive. For example, the above-discussed embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, the terms “first,” “second,” “third,” etc. are used merely as labels, and are not intended to impose numeric requirements on their objects.

What is claimed is:

1. A method including:
communicating a time-varying optical signal through an optical fiber;
transducing the optical signal into a resulting electrical signal;
measuring a peak amplitude of the electrical signal; and
using the measured peak amplitude of the electrical signal to adjust the position of the optical fiber.

2. The method of claim 1, in which the communicating includes transmitting the time-varying optical signal.

3. The method of claim 1, in which the communicating includes receiving the time-varying optical signal.

4. The method of claim 1, in which the transducing includes using a semiconductor light detector.

5. The method of claim 1, in which the transducing includes using an optical signal input of an oscilloscope.

6. The method of claim 1, in which the using the measured peak amplitude of the electrical signal to adjust the position of the optical fiber includes adjusting the position of the optical fiber so as to increase the measured peak amplitude.

7. The method of claim 1, in which the using the measured peak amplitude of the electrical signal to adjust the position of the optical fiber includes adjusting the position of the optical fiber relative to at least one of a light source and a light detector.

8. The method of claim 1, in which the using the measured peak amplitude of the electrical signal to adjust the position of the optical fiber includes adjusting the position of the optical fiber relative to an optical subassembly module.

9. The method of claim 1, further including securing the optical fiber in a position selected using information from the measured peak amplitude of the electrical signal.

10. The method of claim 1, further including:
measuring a power of the electrical signal; and
using the measured power of the electrical signal to adjust the position of the optical fiber.

11. The method of claim 1, further including:
measuring a jitter of the electrical signal; and
using the measured jitter of the electrical signal to adjust the position of the optical fiber.

12. The method of claim 1, further including amplifying the electrical signal using a substantially linear transfer characteristic.

13. The method of claim 12, in which the amplifying the electrical signal includes amplifying a current signal into a resulting voltage signal.

14. A method including:
communicating a time-varying optical signal through an optical fiber;
transducing the optical signal into a resulting electrical signal;
measuring a jitter of the electrical signal; and
using the measured jitter of the electrical signal to adjust the position of the optical fiber.

15. The method of claim 14, in which the communicating includes at least one of:
transmitting the time-varying optical signal; and
receiving the time-varying optical signal.

16. The method of claim 14, in which the transducing includes at least one of:
using a semiconductor light detector; and
using an optical signal input of an oscilloscope.

17. The method of claim 14, in which the using the measured jitter of the electrical signal to adjust the position of the optical fiber includes adjusting the position of the optical fiber so as to decrease the measured jitter.

18. The method of claim 14, further including securing the optical fiber in a position selected using information from the measured jitter of the electrical signal.

19. The method of claim 14, further including:
measuring a power of the electrical signal; and
using the measured power of the electrical signal to adjust the position of the optical fiber.

20. A method including:
communicating a time-varying optical signal through an optical fiber;
transducing the optical signal into a resulting electrical signal using at least one of a semiconductor light detector and an optical signal input of an oscilloscope;
measuring a peak amplitude, a jitter, and a power of the electrical signal;
using the measured peak amplitude, the measured jitter, and the measured power of the electrical signal to adjust the position of the optical fiber relative to at least one of a light source and a light detector, so as to increase the measured peak amplitude and the measured power, and so as to decrease the measured jitter; and
securing the optical fiber in a position selected using information from the measured peak amplitude, the measured jitter, and the measured power of the electrical signal.

21. The method of claim 20, further including amplifying the electrical signal using a substantially linear transfer characteristic.

22. The method of claim 21, in which the amplifying the electrical signal includes amplifying a current signal into a resulting voltage signal.

23. An apparatus including:
a light detector, including an input configured to receive an optical signal and an output configured to provide a resulting electrical signal; and
an optical fiber, secured at a position, relative to the light detector input, using information obtained from a peak amplitude of the electrical signal.

24. The apparatus of claim 23, in which the light detector includes a PIN semiconductor light detector.

25. The apparatus of claim 23, in which the optical fiber is also secured at the position relative to the light detector input using information obtained from a jitter of the electrical signal.

26. The apparatus of claim 25, in which the optical fiber is also secured at the position relative to the light detector input using information obtained from a power of the electrical signal.

27. The apparatus of claim 23, in which the optical fiber is also secured at the position relative to the light detector input using information obtained from a power of the electrical signal.

28. The apparatus of claim 23, further including an amplifier coupled to the output of the light detector.

29. The apparatus of claim 28, in which the amplifier is configured to convert an input current signal into an output voltage signal.

30. The apparatus of claim 28, in which the amplifier includes an adjustable gain characteristic.

31. An apparatus including:
a light source, including an input configured to receive a first electrical signal and an output configured to provide a resulting optical signal; and
an optical fiber, secured at a position, relative to the light source output, using peak amplitude information of a second electrical signal transduced from the optical signal.

32. The apparatus of claim 31, in which the optical fiber is also secured at the position relative to the light source output using information obtained from a jitter of the second electrical signal.

33. The apparatus of claim 32, in which the optical fiber is also secured at the position relative to the light source output using information obtained from a power of the second electrical signal.

34. The apparatus of claim 31, in which the optical fiber is also secured at the position relative to the light source output using information obtained from a power of the second electrical signal.
